(19) United States
(12) Patent Application Publication
(10) Pub. No.: US 2018/0212661 A1
(43) Pub. Date: Jul. 26, 2018

(54) METHOD AND APPARATUS FOR REPORTING CHANNEL STATE INFORMATION AND ELECTRONIC DEVICE

(71) Applicant: HUAWEI TECHNOLOGIES CO., LTD., SHENZHEN (CN)

(72) Inventors: Jianqin LIU, Beijing (CN); Ruiqi ZHANG, Beijing (CN); Kunpeng LIU, Beijing (CN)

(21) Appl. No.: 15/934,701

(22) Filed: Mar. 23, 2018

Related U.S. Application Data
(63) Continuation of application No. PCT/CN2015/090846, filed on Sep. 25, 2015.

(51) Int. Cl. H04B 7/06; H04L 1/00

(52) U.S. Cl. CPC H04B 7/0626; H04W 72/0406; H04L 1/0026; H04B 7/0695

(57) ABSTRACT

A method and an apparatus for reporting channel state information and an electronic device. The method includes: obtaining to-be-reported channel state information CSI, where the channel state information includes a first part and a second part, the first part includes indication information used for beam selection, and the second part includes information other than the indication information used for beam selection; and reporting the channel state information to a first device in a preset reporting manner including a first and a second manner. The first manner includes: transmitting the first part on a first channel, and transmitting the second part on a second channel. The second manner includes: transmitting both the first part and the second part on the first channel. In the present disclosure, reporting of a beam selection indication can be implemented, while a new format for a PUCCH or a PUSCH is not needed.

### CROSS-REFERENCE TO RELATED APPLICATIONS

This application is a continuation of International Patent Application No. PCT/CN2015/090846, filed on Sep. 25, 2015, the disclosure of which is hereby incorporated by reference in its entirety.

### TECHNICAL FIELD

The present disclosure relates to wireless communications technologies, and in particular, to a method and an apparatus for reporting channel state information and an electronic device.

### BACKGROUND

A Multiple-Input Multiple-Output (MIMO) technology has been widely used in a wireless communications system to improve a system capacity and ensure cell coverage. For example, multi-antenna-based transmit diversity, open-loop/closed-loop spatial multiplexing, and Demodulation Reference Signal (DMRS)-based multi-stream transmission are used in a downlink transmission of an Long Term Evolution (LTE) system. DMRS-based multi-stream transmission is a main transmission mode in an LTE-Advanced (LTE-A) system and a subsequent system in communication with the LTE-A system. A procedure of the DMRS-based multi-stream transmission is as follows: User Equipment (UE) first performs a channel measurement according to a Channel State Information-Reference Signal (CSI-RS) configured by an evolved NodeB (eNB). A measurement result includes a transmission rank (Rank), a precoding matrix corresponding to the transmission rank, and a Channel Quality Indicator (CQI) corresponding to the transmission rank and the precoding (Precoding) matrix. Then, the UE feeds back the measurement result to the eNB. The eNB further performs downlink scheduling according to the measurement result fed back by the UE, and sends, according to a scheduling result, a Physical Downlink Shared Channel (PDSCH) to the UE by using a DMRS.

In a communications standard such as a current LTE-A Rel-13 standard, mechanisms for channel state information (CSI) reporting and feedback in three-dimensional MIMO may be classified into a first mechanism in which a CSI-RS resource is not precoded and a second mechanism in which a CSI-RS resource is precoded. In the second mechanism, to eliminate impact caused by a movement of the UE and to improve a CSI feedback accuracy, a base station usually sends multiple sets of precoded candidate reference signal resources to the UE for selection and reporting. Different from the first mechanism, which only CSI reporting is performed, in the second mechanism, the UE further needs to perform extra selection on multiple sets of precoded resources, and reports a beam selection indication to the base station. However, beam selection and reporting are not performed in the first mechanism, and the second mechanism cannot use a solution of the first mechanism as an implementation. Therefore, in the prior art, there is not an effective solution for reporting a beam selection indication in the second mechanism.

### SUMMARY

Embodiments of the present disclosure provide a method and an apparatus for reporting channel state information, so as to implement reporting of a beam selection indication.

To resolve the foregoing technical problem, the present disclosure discloses the following technical solutions:

According to a first aspect, a method for reporting channel state information is provided, the method is applied to a second device, and the method includes:

obtaining to-be-reported channel state information (CSI), where the channel state information includes a first part and a second part, the first part includes indication information used for beam selection, and the second part includes information other than the indication information used for beam selection; and

reporting the channel state information to a first device in a preset reporting manner, where

the preset reporting manner includes a first manner or a second manner;

the first manner includes: transmitting the first part on a first channel, and transmitting the second part on a second channel; and

the second manner includes: transmitting both the first part and the second part on the first channel.

In one embodiment, the first channel is a physical uplink shared channel (PUSCH), and the second channel is a physical uplink control channel (PUCCH).

In one embodiment, for the first manner, a transport format or a coding format of the second part uses a transport format or a coding format of a channel quality indicator (CQI) transmitted on a PUSCH in a 3rd Generation Partnership Project (3GPP) Long Term Evolution (LTE) standard.

In another embodiment, the method further includes:

before reporting the channel state information in a preset reporting manner,

receiving first indication information sent by the first device, where the first indication information is used to indicate a preset reporting manner of the second device.

In one embodiment, the first device notifies the second device of the first indication information using higher-layer signaling or layer-one signaling.

In one embodiment, the layer-one signaling includes control signaling, and the control signaling includes an information bit that is used to carry the first indication information.

In one embodiment, both the first manner and the second manner further include:

transmitting second indication information on the first channel, where the second indication information is used to describe a preset reporting manner that is currently used by the second device.

In one embodiment, a reporting period and a subframe offset of the second part transmitted on the second channel are determined according to the beam selection indication information in the first part.

According to a second aspect, a method for receiving channel state information is provided, the method is applied to a first device, and the method includes:

receiving channel state information (CSI) reported by a second device in a preset reporting manner; and

communicating with the second device according to the channel state information, where

the channel state information includes a first part and a second part, the first part includes indication information used for beam selection, and the second part includes information other than the indication information used for beam selection in the channel state information, where

the preset reporting manner includes a first manner or a second manner, where

the first manner includes: transmitting the first part on a first channel, and transmitting the second part on a second channel; and

the second manner includes: transmitting both the first part and the second part on the first channel.

In one embodiment, the first channel is a physical uplink shared channel (PUSCH), and the second channel is a physical uplink control channel (PUCCH).

In one embodiment,

a transport format or a coding format of the second part uses a transport format or a coding format of a channel quality indicator (CQI) is transmitted on a PUSCH in a 3rd Generation Partnership Project (3GPP) Long Term Evolution (LTE) standard.

In one embodiment, the method further includes:

before receiving channel state information (CSI) that is reported by a second device in a preset reporting manner,

sending first indication information to the second device, where the first indication information is used to indicate a preset reporting manner of the second device.

In one embodiment, the first device notifies the second device of the first indication information by using higher-layer signaling or layer-one signaling.

In one embodiment, the layer-one signaling includes control signaling, and the control signaling includes an information bit that is used to carry the first indication information.

In one embodiment, both the first manner and the second manner further include:

transmitting second indication information on the first channel, where the second indication information is used to describe a preset reporting manner that is currently used by the second device.

In one embodiment, a reporting period and a subframe offset of the second part transmitted on the second channel are determined according to beam selection indication information in the first part.

According to a third aspect, an apparatus for reporting channel state information is provided, the apparatus is applied to a second device, and the apparatus includes:

a channel state information obtaining module, configured to obtain to-be-reported channel state information (CSI), where the channel state information includes a first part and a second part, the first part includes indication information used for beam selection, and the second part includes information other than the indication information used for beam selection; and

a channel state information reporting module, configured to report the channel state information to a first device in a preset reporting manner, where

the preset reporting manner includes a first manner or a second manner;

the first manner includes: transmitting the first part on a first channel, and transmitting the second part on a second channel; and

the second manner includes: transmitting both the first part and the second part on the first channel.

In one embodiment, the first channel is a physical uplink shared channel (PUSCH), and the second channel is a physical uplink control channel (PUCCH).

In one embodiment,

a transport format or a coding format of the second part uses a transport format or a coding format of a channel quality indicator (CQI) transmitted on a PUSCH in a 3rd Generation Partnership Project (3GPP) Long Term Evolution (LTE) standard.

In one embodiment, the apparatus further includes:

a first indication information receiving module, configured to receive first indication information sent by the first device, where the first indication information is used to indicate a preset reporting manner of the second device.

In one embodiment, the first device notifies the second device of the first indication information using higher-layer signaling or layer-one signaling.

In one embodiment, the layer-one signaling includes control signaling, and the control signal includes an information bit that is used to carry the first indication information.

In one embodiment, both the first manner and the second manner further include:

transmitting second indication information on the first channel, where the second indication information is used to describe a preset reporting manner that is currently used by the second device.

In one embodiment, a reporting period and a subframe offset of the second part transmitted on the second channel are determined according to beam selection indication information in the first part.

According to a fourth aspect, an apparatus for receiving channel state information is provided, the apparatus is applied to a first device, and the apparatus includes:

a channel state information receiving module, configured to receive channel state information (CSI) that is reported by a second device in a preset reporting manner; and

a communications module, configured to communicate with the second device according to the channel state information, where

the channel state information includes a first part and a second part, the first part includes indication information used for beam selection, and the second part includes information other than the indication information used for beam selection; and

the preset reporting manner includes a first manner or a second manner;

the first manner includes: transmitting the first part on a first channel, and transmitting the second part on a second channel; and

the second manner includes: transmitting both the first part and the second part on the first channel.

In one embodiment, the first channel is a physical uplink shared channel (PUSCH), and the second channel is a physical uplink control channel (PUCCH).

In one embodiment,

for the first manner, a transport format or a coding format of the second part uses a transport format or a coding format of a channel quality indicator (CQI) transmitted on a PUSCH in a 3rd Generation Partnership Project (3GPP) Long Term Evolution (LTE) standard.

In one embodiment, the apparatus further includes:

a first indication information sending module, configured to send first indication information to the second device, where the first indication information is used to indicate a preset reporting manner of the second device.

In one embodiment, the first device notifies the second device of the first indication information using higher-layer signaling or layer-one signaling.

In one embodiment, the layer-one signaling includes control signaling, and the control signaling includes an information bit that is used to carry the first indication information.

In one embodiment, both the first manner and the second manner further include:

transmitting second indication information on the first channel, where the second indication information is used to describe a preset reporting manner that is currently used by the second device.

In one embodiment, a reporting period and a subframe offset of the second part transmitted on the second channel are determined according to beam selection indication information in the first part.

According to a fifth aspect, an electronic device is provided, and the electronic device includes a processor, a memory, a transceiver module, and a system bus; the processor, the memory, and the transceiver module are coupled together using the system bus, the transceiver module is configured to receive and send a wireless signal, the memory is configured to store an instruction that can be executed by the processor, and

the processor is configured to:

obtain to-be-reported channel state information (CSI), where the channel state information includes a first part and a second part, the first part includes indication information used for beam selection, and the second part includes information other than the indication information used for beam selection; and

report the channel state information to a first device in a preset reporting manner, where

the preset reporting manner includes a first manner or a second manner;

the first manner includes: transmitting the first part on a first channel, and transmitting the second part on a second channel; and

the second manner includes: transmitting both the first part and the second part on the first channel.

To resolve the foregoing technical problem, the present disclosure discloses the following technical solutions:

In the embodiments of the present disclosure, the beam selection indication is transmitted on the first channel such as a PUSCH to implement the reporting of a beam selection indication, and a new format for a PUCCH or a PUSCH is not needed. Further, performance of transmitting the CSI on the PUSCH is relatively good with a small modification to the standard (e.g., the LTE-A Rel-13 standard), and the degree of freedom in base station configuration and implementation is great for an improved transmission performance.

### BRIEF DESCRIPTION OF DRAWINGS

To describe the technical solutions in the embodiments of the present disclosure more clearly, the following briefly describes the accompanying drawings required for describing the embodiments or the prior art. Apparently, a person of ordinary skill in the art may still derive other drawings from these accompanying drawings without creative efforts.

FIG. 1 is a flowchart of a method for reporting channel state information according to an embodiment of the present disclosure;

FIG. 2 is a flowchart of a method for reporting channel state information according to an embodiment of the present disclosure;

FIG. 3 is a flowchart of a method for reporting channel state information according to an embodiment of the present disclosure;

FIG. 4 is a flowchart of a method for reporting channel state information according to an embodiment of the present disclosure;

FIG. 5 is a block diagram of an apparatus for reporting channel state information according to an embodiment of the present disclosure;

FIG. 6 is a block diagram of an apparatus for reporting channel state information according to an embodiment of the present disclosure;

FIG. 7 is a block diagram of an apparatus for reporting channel state information according to an embodiment of the present disclosure;

FIG. 8 is a block diagram of an apparatus for reporting channel state information according to an embodiment of the present disclosure; and

FIG. 9 is a schematic diagram of an electronic device according to an embodiment of the present disclosure.

### DESCRIPTION OF EMBODIMENTS

To make a person skilled in the art understand the technical solutions in the embodiments of the present disclosure better, and make the objectives, features, and advantages of the embodiments of the present disclosure clearer, the following further describes the technical solutions in the embodiments of the present disclosure in detail with reference to the accompanying drawings.

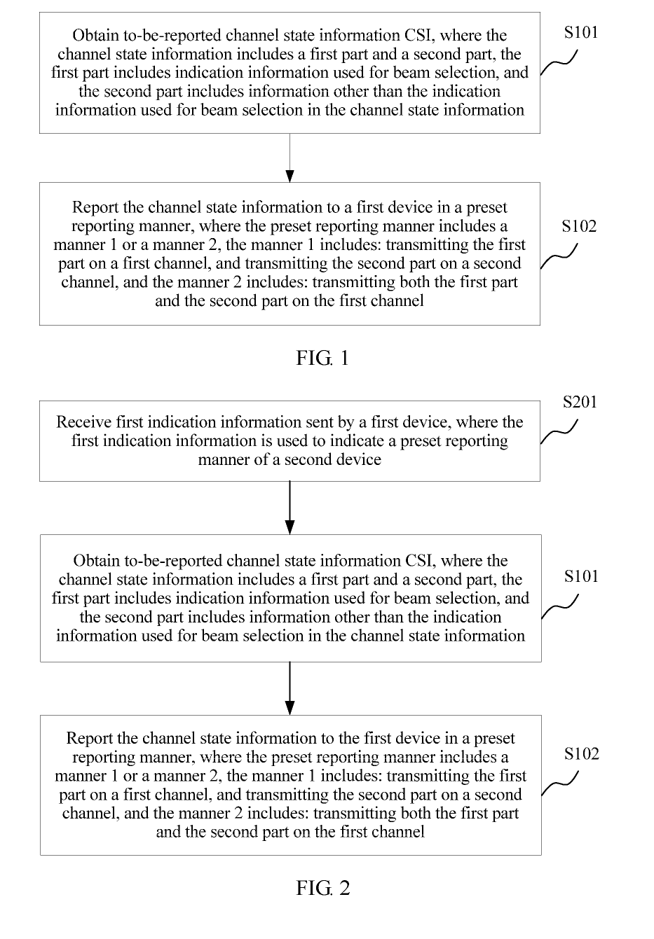

FIG. 1 is a flowchart of a method for reporting channel state information according to an embodiment of the present disclosure. The method may be applied to a second device. For example, the second device may be a user terminal such as a mobile phone or a tablet computer.

As shown in FIG. 1, the method may include:

In operation S101, to-be-reported channel state information (CSI) is obtained, where the channel state information includes a first part and a second part, the first part includes indication information used for beam selection, and the second part includes information other than the indication information used for beam selection.

In operation S102, the channel state information is reported to a first device in a preset reporting manner.

The preset reporting manner includes a first manner or a second manner.

The first manner includes: transmitting the first part on a first channel, and transmitting the second part on a second channel.

The second manner includes: transmitting both the first part and the second part on the first channel.

In an example, the first channel is a PUSCH, and the second channel is a PUCCH.

In this embodiment, the to-be-reported channel state information is first divided into two parts. The first part includes indication information used for beam selection, and the second part includes information such as a CQI, an RI (rank indicator), and a PTI (precoding type indicator), other than the indication information used for beam selection in the channel state information.

Then, the second device may select one manner from the first manner and the second manner to report the channel state information. In an example, the second device may autonomously select one manner, or may select one manner according to an indication of the first device.

In an example, in the first manner, a reporting amount used for a beam selection indication, such as a beam selection indication in a bit stream format or a beam selection indication in a precoding matrix format, may be transmitted on the PUSCH in a manner of joint transmission of the PUSCH and the PUCCH during reporting. Channel state information other than the beam selection indication, for example, the channel state information such as the CQI, the RI, and the PTI, is transmitted on the PUCCH. Based on a combination of report information of the beam selection indication on the PUSCH and report information of the other channel state information on the PUCCH, a base station obtains complete channel state information.

In some embodiments of the present disclosure,

for the first manner, a transport format or a coding format of the second part uses a transport format or a coding format of a channel quality indicator CQI transmitted on a PUSCH in a 3rd Generation Partnership Project 3GPP Long Term Evolution LTE standard. For example, the transport format of the channel quality indicator CQI may include a mapping manner of the CQI on the PUSCH.

Reporting of the channel state information on the PUCCH may use an existing PUCCH report type and mode in a current standard. For example, all PUCCH report modes such as PUCCH 1-0, 1-1, 2-0, and 2-1 can be used. However, a report format or a coding format used for a beam selection indication on the PUSCH may reuse a PUSCH report format or coding format of the CQI in a current LTE standard.

For the second manner, both the first part and the second part may be transmitted on the PUSCH. Higher-layer signaling or layer-one dynamic signaling is used to indicate whether the channel state information transmitted on the PUSCH is transmitted in the first manner in which only the first part of the channel state information is included or in the second manner in which both the first part and the second part of the channel state information are included. Alternatively, an indication field is added to a specific PUSCH report mode, and the indication field is used to indicate whether the report mode is the first manner or the second manner.

As shown in FIG. 2, in some embodiments of the present disclosure, the method further includes:

before reporting the channel state information in a preset reporting manner, performing the following operations of:

In operation 201, first indication information sent by the first device is received, where the first indication information is used to indicate a preset reporting manner of the second device.

For example, a base station that is used as the first device instructs, by using the first indication information, the second device to perform reporting in the first manner, and the second device such as UE performs reporting in the first manner.

In some embodiments of the present disclosure, the first device notifies the second device of the first indication information by using higher-layer signaling or layer-one signaling.

Optionally, the layer-one signaling includes control signaling, and the control signaling includes an information bit that is used to carry the first indication information.

Reporting of a beam selection indication on the PUSCH may be triggered by the higher-layer signaling such as Radio Resource Control (RRC) signaling, or the layer-one dynamic signaling such as Downlink Control Information (DCI) signaling. Optionally, when the reporting of a beam selection indication on the PUSCH is used, a trigger field (an information bit) of one bit used for reporting a beam selection indication may be added to DCI, similar to a current trigger manner of aperiodic PUSCH reporting. When the trigger field is set to 1, the reporting of a beam selection indication on the PUSCH is triggered, and when the trigger field is set to 0, the reporting of a beam selection indication on the PUSCH is not triggered.

In addition, the second device may also autonomously determine whether to use the first manner or the second manner to perform reporting, and notify the first device of the reporting manner. Therefore, in some embodiments of the present disclosure, both the first manner and the second manner can include:

transmitting second indication information on the first channel, where the second indication information is used to describe a preset reporting manner that is currently used by the second device.

A report type indicator field may be added to a PUSCH report mode, for example, an Report Type Indicator (RTI) field of one bit is added. The field can be used to indicate whether current PUSCH reporting is in the first manner or the second manner. Optionally, when the RTI is 0, the report type is the first manner of PUSCH reporting; and when the RTI is 1, the report type is the second manner of PUSCH reporting.

In some embodiments of the present disclosure, in the first manner, a reporting period and a subframe offset of the second part transmitted on the second channel are determined according to beam selection indication information in the first part. For example, the reporting period or the subframe offset is an integer multiple of a quantity of candidate beams used for beam selection.

In a second mechanism, when a user is configured to support reporting of multiple pieces of CSI for multiple candidate beams, a current PUCCH CSI report format needs to be correspondingly extended, to support joint reporting of multiple sets of CSI. Setting of a reporting period, a reporting subframe offset, and the multiple pieces of CSI is related to the quantity of candidate beams used for bean selection. Optionally, the reporting period of the multiple pieces of CSI is an integer multiple of a reporting period of one piece of CSI in a current standard.

In addition, for some new Rel-13 users who use a PUCCH report mode, reporting of a beam selection indication does not need to be performed in some scenarios, and therefore, CSI reporting includes only report information that is correspondingly transmitted on the PUCCH. In this case, the base station needs to notify, by using the higher-layer signaling or other layer-one signaling, the user whether a CSI report mode is a manner of joint reporting and transmission of the PUSCH and the PUCCH or a manner of reporting and transmission of only the PUCCH.

In one embodiment, the beam selection indication is transmitted on the first channel such as a PUSCH, the reporting of a beam selection indication is implemented in the second mechanism, and a new format of a PUCCH or a PUSCH do not need to be designed. Further, performance of transmitting the CSI on the PUSCH is relatively good;

the modification to the standard (e.g., LTE-A Rel-13 standard) is small; the degree of freedom in base station configuration and implementation is great for an improved transmission performance.

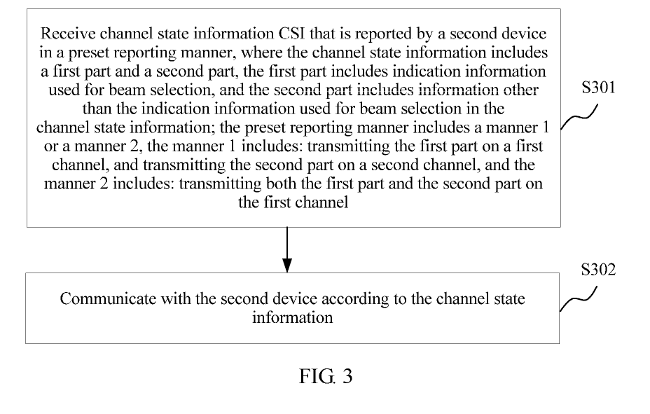

FIG. 3 is a flowchart of a method for reporting channel state information according to an embodiment of the present disclosure. The method may be applied to a first device. For example, the first device may be a base station or the like.

As shown in FIG. 3, the method may include:

In operation S301, CSI that is reported by a second device in a preset reporting manner is received.

The channel state information includes a first part and a second part, the first part includes indication information used for beam selection, and the second part includes information other than the indication information used for beam selection in the channel state information.

The preset reporting manner includes a first manner or a second manner.

The first manner includes: transmitting the first part on a first channel, and transmitting the second part on a second channel.

The second manner includes: transmitting both the first part and the second part on the first channel.

In operation S302, the second device is communicated with according to the channel state information.

In some embodiments of the present disclosure, the first channel is a physical uplink shared channel PUSCH, and the second channel is a physical uplink control channel PUCCH.

In some embodiments of the present disclosure,

a transport format or a coding format of the second part uses a transport format or a coding format of a CQI transmitted on a PUSCH in a 3GPP Long Term Evolution LTE standard.

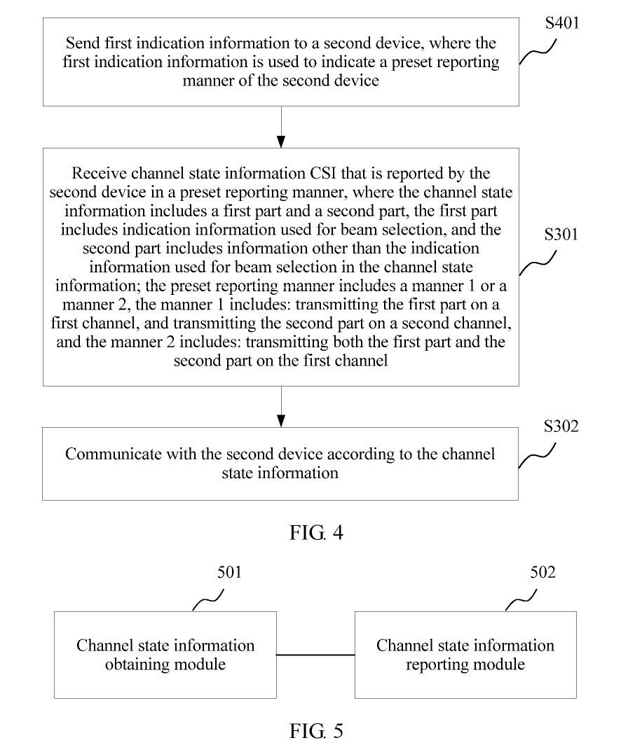

As shown in FIG. 4, in some embodiments of the present disclosure, the method may further include:

before the receiving channel state information CSI that is reported by a second device in a preset reporting manner,

In operation S401, first indication information is sent to the second device, where the first indication information is used to indicate a preset reporting manner of the second device.

In some embodiments of the present disclosure, the first device notifies the second device of the first indication information by using higher-layer signaling or layer-one signaling.

In some embodiments of the present disclosure, the layer-one signaling includes control signaling, and the control signaling includes an information bit that is used to carry the first indication information.

In some embodiments of the present disclosure, both the first manner and the second manner may further include:

transmitting second indication information on the first channel, where the second indication information is used to describe a preset reporting manner that is currently used by the second device.

In some embodiments of the present disclosure, in the first manner, a reporting period and a subframe offset of the second part on the second channel are determined according to beam selection indication information in the first part.

In one embodiment, a beam selection indication is transmitted on the first channel such as a PUSCH, reporting of a beam selection indication can be implemented in a second mechanism, and a new format for a PUCCH or a PUSCH is not needed. Further, performance of transmitting the CSI on the PUSCH is relatively good; the modification to the standard (e.g., LTE-A Rel-13 standard) is small, and a degree of freedom in base station configuration and implementation is great with an improved transmission performance.

The following is an apparatus embodiment of the present disclosure, and the apparatus embodiment may be used to execute the method embodiments of the present disclosure. For details not disclosed in the apparatus embodiment of the present disclosure, refer to the method embodiment of the present disclosure.

FIG. 5 is a block diagram of an apparatus for reporting channel state information according to an embodiment of the present disclosure. The apparatus may be applied to a second device. For example, the second device may be a user terminal such as a mobile phone or a tablet computer.

As shown in FIG. 5, the apparatus may include:

a channel state information obtaining module 501, configured to obtain to-be-reported channel state information CSI, where the channel state information includes a first part and a second part, the first part includes indication information used for beam selection, and the second part includes information other than the indication information used for beam selection in the channel state information; and

a channel state information reporting module 502, configured to report the channel state information to a first device in a preset reporting manner.

The preset reporting manner includes a first manner or a second manner.

The first manner includes: transmitting the first part on a first channel, and transmitting the second part on a second channel.

The second manner includes: transmitting both the first part and the second part on the first channel.

In some embodiments of the present disclosure, the first channel is a physical uplink shared channel PUSCH, and the second channel is a physical uplink control channel PUCCH.

In some embodiments of the present disclosure,

a transport format or a coding format of the second part uses a transport format or a coding format of a CQI transmitted on a PUSCH in a 3GPP Long Term Evolution LTE standard.

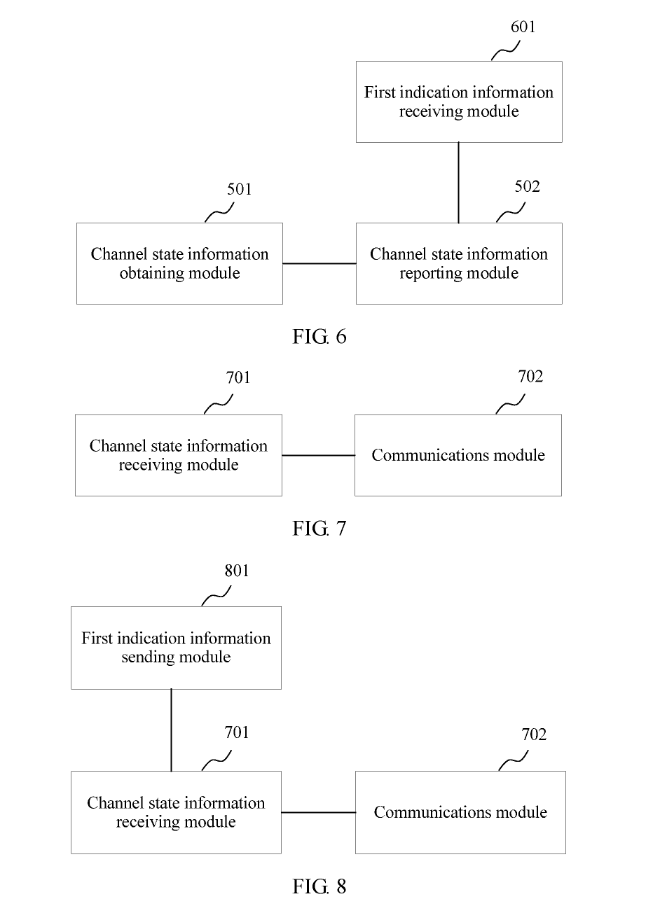

As shown in FIG. 6, in some embodiments of the present disclosure, the apparatus may further include:

a first indication information receiving module 601, configured to receive first indication information sent by the first device, where the first indication information is used to indicate a preset reporting manner of the second device.

In some embodiments of the present disclosure, the first device notifies the second device of the first indication information by using higher-layer signaling or layer-one signaling.

In some embodiments of the present disclosure, the layer-one signaling is control signaling, and the control signaling includes an information bit that is used to carry the first indication information.

In some embodiments of the present disclosure, both the first manner and the second manner further include:

transmitting second indication information on the first channel, where the second indication information is used to describe a preset reporting manner that is currently used by the second device.

In some embodiments of the present disclosure, in the first manner, a reporting period and a subframe offset of the second part on the second channel are determined according to beam selection indication information in the first part.

In one embodiment, a beam selection indication is transmitted on the first channel such as a PUSCH, to report a beam selection indication implemented in a second mechanism so a new format for a PUCCH or a PUSCH is not need. Further, performance of transmitting the CSI on the PUSCH is relatively good; the modification to the standard (e.g., LTE-A Rel-13 standard) is small; the degree of freedom in base station configuration and implementation is great, and the transmission performance is improved.

For the apparatus embodiment, a specific manner in which each module executes an operation has been described in detail in the related method embodiment, and details are not described herein.

FIG. 7 is a block diagram of an apparatus for reporting channel state information according to an embodiment of the present disclosure. The apparatus may be applied to a first device. For example, the first device may be a base station or the like.

As shown in FIG. 7, the apparatus may include:

a channel state information receiving module 701, configured to receive channel state information CSI that is reported by a second device in a preset reporting manner; and

a communications module 702, configured to communicate with the second device according to the channel state information.

The channel state information includes a first part and a second part, the first part includes indication information used for beam selection, and the second part includes information other than the indication information used for beam selection in the channel state information.

The preset reporting manner includes a first manner or a second manner.

The first manner includes: transmitting the first part on a first channel, and transmitting the second part on a second channel.

The second manner includes: transmitting both the first part and the second part on the first channel.

In some embodiments of the present disclosure, the first channel is a physical uplink shared channel PUSCH, and the second channel is a physical uplink control channel PUCCH.

In some embodiments of the present disclosure,

a transport format or a coding format of the second part uses a transport format or a coding format of a CQI transmitted on a PUSCH in a 3GPP Long Term Evolution LTE standard.

As shown in FIG. 8, in some embodiments of the present disclosure, the apparatus may further include:

a first indication information sending module 801, configured to send first indication information to the second device, where the first indication information is used to indicate a preset reporting manner of the second device.

In some embodiments of the present disclosure, the first device notifies the second device of the first indication information by using higher-layer signaling or layer-one signaling.

In some embodiments of the present disclosure, the layer-one signaling includes control signaling, and the control signaling includes an information bit that is used to carry the first indication information.

In some embodiments of the present disclosure, both the first manner and the second manner further include:

transmitting second indication information on the first channel, where the second indication information is used to describe a preset reporting manner that is currently used by the second device.

In some embodiments of the present disclosure, in the first manner, a reporting period and a subframe offset of the second part on the second channel are determined according to beam selection indication information in the first part.

In one embodiment, a beam selection indication is transmitted on the first channel such as a PUSCH for reporting of a beam selection indication implemented in a second mechanism, and a new format of a PUCCH or a PUSCH is not need. Further, performance of transmitting the CSI on the PUSCH is relatively good, the modification to the standard (e.g., LTE-A Rel-13 standard) is small, and the degree of freedom in base station configuration and implementation is great for an improved transmission performance.

For the apparatus embodiment, a specific manner in which each module executes an operation has been described in detail in the related method embodiment, and details are not described herein.

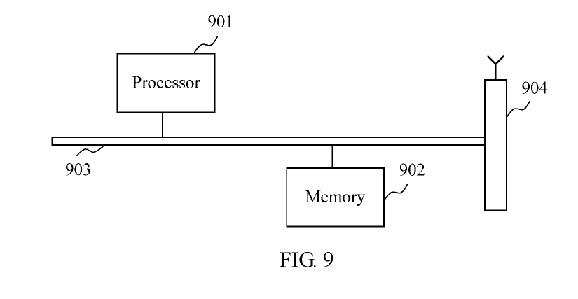

FIG. 9 is a schematic diagram of an electronic device according to an embodiment of the present disclosure. For example, the electronic device may be a user terminal such as a mobile phone or a tablet computer.

As shown in FIG. 9, the electronic device includes a processor 901, a memory 902, a transceiver module 903, and a system bus 904. The processor 901, the memory 902, and the transceiver module 903 are connected by using the system bus 904. The transceiver module 903 is configured to receive and send a wireless signal, and the memory 902 is configured to store an instruction that can be executed by the processor 901.

The processor 901 is configured to:

obtain to-be-reported channel state information CSI, where the channel state information includes a first part and a second part, the first part includes indication information used for beam selection, and the second part includes information other than the indication information used for beam selection in the channel state information; and

report the channel state information to a first device in a preset reporting manner.

The preset reporting manner includes a first manner or a second manner.

The first manner includes: transmitting the first part on a first channel, and transmitting the second part on a second channel.

The second manner includes: transmitting both the first part and the second part on the first channel.

The present disclosure can be described in the general context of executable computer instructions executed by a computer, for example, a program module. Generally, the program module includes a routine, program, object, component, data structure, and the like for executing a particular task or implementing a particular abstract data type. The present disclosure may also be practiced in distributed computing environments in which tasks are performed by remote processing devices that are connected through a communications network. In a distributed computing environment, program modules may be located in both local and remote computer storage media including storage devices.

It should be noted that in this specification, relational terms such as first and second are only used to distinguish one entity or operation from another, and do not necessarily require or imply that any actual relationship or sequence exists between these entities or operations. Moreover, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the existence of additional identical elements in the process, method, article, or apparatus that includes the element.

The foregoing descriptions are merely specific implementations of the present disclosure. It should be noted that a person of ordinary skill in the art may make several improvements or polishing without departing from the principle of the present disclosure and the improvements or polishing shall fall within the protection scope of the present disclosure.

What is claimed is:

1. A method for reporting channel state information, the method comprises:
obtaining to-be-reported channel state information (CSI), wherein the channel state information comprises a first part and a second part, the first part comprises indication information used for beam selection, and the second part comprises information other than the indication information used for beam selection; and
reporting the channel state information to a first device in a preset reporting manner, wherein
the preset reporting manner comprises a first manner or a second manner, wherein
the first manner comprises: transmitting the first part on a first channel, and transmitting the second part on a second channel; and
the second manner comprises: transmitting both the first part and the second part on the first channel.

2. The method according to claim 1, wherein the first channel is a physical uplink shared channel (PUSCH), and the second channel is a physical uplink control channel (PUCCH).

3. The method according to claim 1, wherein the method further comprises:
before reporting the channel state information in a preset reporting manner, receiving first indication information sent by the first device, wherein the first indication information is used to indicate a preset reporting manner of a second device.

4. The method according to claim 3, wherein the first device notifies the second device of the first indication information using higher-layer signaling or layer-one signaling.

5. An apparatus for reporting channel state information, the apparatus comprises:
a channel state information obtaining circuit, configured to obtain to-be-reported channel state information (CSI), wherein the channel state information comprises a first part and a second part, the first part comprises indication information used for beam selection, and the second part comprises information other than the indication information used for beam selection; and
a channel state information reporting circuit, configured to report the channel state information to a first device in a preset reporting manner, wherein
the preset reporting manner comprises a first manner or a second manner, wherein
the first manner comprises: transmitting the first part on a first channel, and transmitting the second part on a second channel; and
the second manner comprises: transmitting both the first part and the second part on the first channel.

6. The apparatus according to claim 5, wherein the first channel is a physical uplink shared channel (PUSCH), and the second channel is a physical uplink control channel (PUCCH).

7. The apparatus according to claim 6, wherein
for the first manner, a transport format or a coding format of the second part uses a transport format or a coding format of a channel quality indicator (CQI) transmitted on a PUSCH in a 3rd Generation Partnership Project (3GPP) Long Term Evolution (LTE) standard.

8. The apparatus according to claim 5, wherein the apparatus further comprises:
a first indication information receiving circuit, configured to receive first indication information sent by the first device, wherein the first indication information is used to indicate a preset reporting manner of a second device.

9. The apparatus according to claim 8, wherein the first device notifies the second device of the first indication information by using higher-layer signaling or layer-one signaling.

10. The apparatus according to claim 9, wherein the layer-one signaling includes control signaling, and the control signaling comprises an information bit that is used to carry the first indication information.

11. The apparatus according to claim 5, wherein both the first manner and the second manner further comprise:
transmitting second indication information on the first channel, wherein the second indication information is used to describe a preset reporting manner that is currently used by the second device.

12. The apparatus according to claim 5, wherein in the first manner, a reporting period and a subframe offset of the second part transmitted on the second channel are determined according to beam selection indication information in the first part.

13. An apparatus for receiving channel state information, the apparatus comprises:
a channel state information receiving circuit, configured to receive channel state information (CSI) that is reported by a second device in a preset reporting manner; and
a communications circuit, configured to communicate with the second device according to the channel state information, wherein
the channel state information comprises a first part and a second part, the first part comprises indication information used for beam selection, and the second part comprises information other than the indication information used for beam selection in the channel state information, and wherein
the preset reporting manner comprises a first manner or a second manner, and wherein
the first manner comprises: transmitting the first part on a first channel, and transmitting the second part on a second channel; and
the second manner comprises: transmitting both the first part and the second part on the first channel.

14. The apparatus according to claim 13, wherein the first channel is a physical uplink shared channel (PUSCH), and the second channel is a physical uplink control channel (PUCCH).

15. The apparatus according to claim 14, wherein
for the first manner, a transport format or a coding format of the second part uses a transport format or a coding format of a channel quality indicator (CQI) transmitted on a PUSCH in a 3rd Generation Partnership Project (3GPP) Long Term Evolution (LTE) standard.

16. The apparatus according to claim 13, wherein the apparatus further comprises:
a first indication information sending circuit, configured to send first indication information to the second device, wherein the first indication information is used to indicate a preset reporting manner of a second device.

17. The apparatus according to claim 16, wherein the first device notifies the second device of the first indication information using higher-layer signaling or layer-one signaling.

18. The apparatus according to claim 17, wherein the layer-one signaling includes control signaling, and the control signaling comprises an information bit that is used to carry the first indication information.

19. The apparatus according to claim 13, wherein both the first manner and the second manner further comprise:
transmitting second indication information on the first channel, wherein the second indication information is used to describe a preset reporting manner that is currently used by the second device.

20. The apparatus according to claim 13, wherein in the first manner, a reporting period and a subframe offset of the second part transmitted on the second channel are determined according to beam selection indication information in the first part.
